(19) United States
(12) Patent Application Publication
(10) Pub. No.: US 2026/0042050 A1
(43) Pub. Date: Feb. 12, 2026

(54) AMINE-BASED CARBON CAPTURE SOLVENT DEGRADATION MONITORING

(71) Applicant: UNIVERSITY OF REGINA, Regina, Saskatchewan (CA)

(72) Inventors: Raphael IDEM, Regina, Saskatchewan (CA); Ebenezer Kofi MENSAH, Edmonton, Alberta (CA); Teeradet SUPAP, Regina, Saskatchewan (CA); Jessica NARKU-TETTEH, Regina, Saskatchewan (CA)

(21) Appl. No.: 19/163,498

(22) PCT Filed: Feb. 26, 2024
(86) PCT No.: PCT/CA2024/050234

§ 371 Date: Sep. 24, 2025

Related U.S. Application Data
(60) Provisional application No. 63/451,258, filed on Mar. 10, 2023.

(51) Int. Cl. B01D 53/14; B01D 53/62; B01D 53/78; B01D 53/96

(52) U.S. Cl. CPC B01D 53/1412; B01D 53/1425; B01D 53/1475; B01D 53/1493; B01D 53/62; B01D 53/78; B01D 53/96; B01D 2252/20484; B01D 2257/504; B01D 2258/0283

(57) ABSTRACT

A system for monitoring deterioration of an amine-based carbon capture solvent. The system includes at least one processor and at least one data storage device communicatively coupled to the at least one processor. The at least one data storage device has stored thereon computer-executable instructions for operating the at least one processor to receive operational measurements of a plurality of properties of the amine-based carbon capture solvent in a solvent circulation system of a carbon capture plant during operation of the carbon capture plant; apply a predictive model to the operational measurements to generate a predicted concentration, the predicted concentration being a prediction of a concentration of a component of the amine-based carbon capture solvent; and generate a deterioration detection event in response to determining that a difference between the predicted concentration and a desired concentration is outside a predetermined difference threshold.

### FIELD

The present disclosure relates generally to carbon capture, and, more specifically, to monitoring for degradation of amine-based carbon capture solvents during carbon capture plant operation.

### BACKGROUND

The following paragraphs are not an admission that anything discussed in them is prior art or part of the knowledge of persons skilled in the art.

Carbon capture and storage technologies are used to remove carbon dioxide (CO₂) from flue gas produced when burning, e.g., fossil fuels. In many cases, carbon capture and storage technologies are used to capture CO₂ emitted by combustion, whereupon the CO₂ is compressed and transported to a storage site with a possibility of recycling the stored carbon dioxide for future use and sequestration or depositing it in, e.g., the ground or ocean-bedrock sediment layer to isolate it from the atmosphere.

Amine-based post combustion capture technology is one of the current carbon capture technologies and has been seen as offering a high process efficiency. However, amine-based post combustion capture technology suffers from solvent deterioration. Solvent deterioration occurs from, e.g., differential evaporation rates and/or the reaction of the amine-based carbon capture solvent with impurities like O₂, NOₓ, and SOₓ in the flue gas stream. Solvent deterioration affects the capacity and performance of the amine-based carbon capture solvent, as well as the overall efficiency of the carbon capture process.

### SUMMARY

The following summary is intended to introduce the reader to various aspects of the applicant's teaching, but not to define any invention.

According to some aspects, there is provided a system for monitoring for deterioration of an amine-based carbon capture solvent, comprising at least one processor; at least one data storage device communicatively coupled to the at least one processor, the at least one data storage device having stored thereon computer-executable instructions for operating the at least one processor to: receive operational measurements of a plurality of properties of the amine-based carbon capture solvent in a solvent circulation system of a carbon capture plant during operation of the carbon capture plant; and apply a predictive model to the operational measurements to generate a predicted concentration, the predicted concentration being a prediction of a concentration of a component of the amine-based carbon capture solvent (e.g., a concentration of an original component of the solvent or a concentration of a degradation product); and generate a deterioration detection event in response to determining that a difference between the predicted concentration and a desired concentration is outside a predetermined difference threshold.

In some examples, the computer-executable instructions include instructions for operating the at least one processor to determine a remediation action to adjust the predicted concentration towards the desired concentration, the remediation action selected from a set of remediation options stored on the at least one data storage device.

In some examples, the system further comprises the carbon capture plant, the carbon capture plant including a plurality of sensors arranged to generate the operational measurements, the plurality of sensors arranged to measure the amine-based carbon capture solvent while the amine-based carbon capture solvent is in a lean amine path from a desorber of the solvent circulation system to generate the operational measurements.

In some examples, the predicted concentration of the component includes a predicted amine concentration of an amine component of the amine-based carbon capture solvent.

In some examples, the predicted concentration of the component includes a predicted degradation product concentration of a degradation product component of the amine-based carbon capture solvent.

In some examples, the predicted degradation product concentration of the degradation product component includes a predicted ammonium or formate ion concentration of an ammonium formate component of the amine-based carbon capture solvent or a predicted ammonium or acetate ion concentration of an ammonium acetate component of the amine-based carbon capture solvent.

In some examples, the plurality of properties is selected from a group of properties including a refractive index, a density, a viscosity, an ionic conductivity, a thermal conductivity, a heat capacity, an electrical conductivity, a surface tension, an infrared (IR) radiation, or an ultra violet (UV) radiation.

In some examples, the plurality of properties includes a refractive index, a density, a viscosity, and an ionic conductivity.

In some examples, the predictive model is a regression model.

In some examples, the predictive model incudes a trained artificial neural network.

In some examples, the operational measurements are measurements of the amine-based carbon capture solvent when the amine-based carbon capture solvent is at a temperature greater than 35° C.

According to some aspects, there is provided a system for monitoring for deterioration of an amine-based carbon capture solvent, comprising at least one processor; at least one data storage device communicatively coupled to the at least one processor, the at least one data storage device having stored thereon computer-executable instructions for operating the at least one processor to: receive operational measurements of a plurality of properties of the amine-based carbon capture solvent in a lean amine path from a desorber of a solvent circulation system of a carbon capture plant during operation of the carbon capture plant while the amine-based carbon capture solvent is at a temperature of at least 35° C.; and apply a first predictive model to the operational measurements to generate a predicted amine concentration of an amine component of the amine-based carbon capture solvent; apply a second predictive model to the operational measurements to generate a predicted degradation product concentration of a degradation product component of the amine-based carbon capture solvent, the second predictive model being different from the first predictive model; generate a physical change detection event in response to determining that an amine concentration difference between the predicted amine concentration and a desired amine concentration is outside a predetermined amine difference threshold; and generate a chemical degradation detection event in response to determining that a degradation product concentration difference between the predicted degradation product concentration and a desired degradation product concentration is outside a predetermined degradation product difference threshold.

In some examples, the first predictive model includes a machine learned model trained using property measurements of a training amine-based carbon capture solvent taken while the training amine-based carbon capture solvent is at a temperature of at least 35° C.

In some examples, the second predictive model includes a machine learned model trained using property measurements of a training amine-based carbon capture solvent taken while the training amine-based carbon capture solvent is at a temperature of at least 35° C.

In some examples, the plurality of properties includes a refractive index, a density, a viscosity, and an ionic conductivity.

According to some aspects, there is provided a method of detecting deterioration of an amine-based carbon capture solvent, comprising receiving operational measurements of a plurality of properties of the amine-based carbon capture solvent in a solvent circulation system of a carbon capture plant during operation of the carbon capture plant; and applying a predictive model to the operational measurements to generate a predicted concentration, the predicted concentration being a prediction of a concentration of a component of the amine-based carbon capture solvent; determining a difference between the predicted concentration and a desired concentration; determining that the difference is outside a predetermined threshold; and generating a deterioration detection event in response to determining that the difference is outside the predetermined threshold.

In some examples, the method further comprises determining a remediation action to adjust the predicted concentration towards the desired concentration.

In some examples, the method further comprises capturing the operational measurements from the amine-based solvent while the amine-based carbon capture solvent is in a lean amine path from a desorber of the solvent circulation system.

In some examples, the plurality of properties is selected from a group of properties including a refractive index, a density, a viscosity, an ionic conductivity, a thermal conductivity, a heat capacity, an electrical conductivity, a surface tension, an infrared (IR) radiation generated, or ultra violet (UV) radiation generated.

In some examples, the plurality of properties includes a refractive index, a density, a viscosity, and an ionic conductivity.

A system for detecting deterioration of an amine-based carbon capture solvent, comprising: at least one processor; at least one data storage device communicatively coupled to the at least one processor, the at least one data storage device having stored thereon computer-executable instructions for operating the at least one processor to: generate an interface for receiving operational measurements of a plurality of properties of the amine-based carbon capture solvent in a solvent circulation system of a carbon capture plant during operation of the carbon capture plant, apply a predictive model to the operational measurements to generate a predicted concentration, the predicted concentration being a prediction of a concentration of a component of the amine-based carbon capture solvent or of a degradation product, determine a difference between the predicted concentration and a desired concentration, determine that the difference is outside a predetermined threshold, generate a deterioration detection event in response to determining that the difference is outside the predetermined threshold, and determine a remediation action to adjust the predicted concentration towards the desired concentration.

A method of detecting deterioration of an amine-based carbon capture solvent, comprising: generating a user interface, the user interface prompting a user to provide operational measurements of a plurality of properties of the amine-based carbon capture solvent in a solvent circulation system of a carbon capture plant during operation of the carbon capture plant; receiving, via the user interface, the operational measurements of the plurality of properties of the amine-based carbon capture solvent in the solvent circulation system of the carbon capture plant during operation of the carbon capture plant; apply a predictive model to the operational measurements to generate a predicted concentration, the predicted concentration being a prediction of a concentration of a component of the amine-based carbon capture solvent or of a degradation product; determine a difference between the predicted concentration and a desired concentration; determine that the difference is outside a predetermined threshold; generate a deterioration detection event in response to determining that the difference is outside the predetermined threshold; and determine a remediation action to adjust the predicted concentration towards the desired concentration.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a schematic diagram of a system for monitoring deterioration of an amine-based carbon capture solvent;

FIG. 2 is a flow chart of a method of detecting deterioration of an amine-based carbon capture solvent;

FIG. 3 is a parity plot of a training dataset for a first predictive model;

FIG. 4 is a parity plot of a validation dataset for the first predictive model;

FIG. 5 is a first schematic diagram of the architecture of a second predictive model;

FIG. 6 is a flow chart of a method of developing the second predictive model;

FIG. 7 is a plot of the root mean squared error for training and validation datasets against a number of neurons in a hidden layer of the second predictive model;

FIG. 8 is a second schematic diagram of the architecture of the second predictive model;

FIG. 9 is a plot of a mean squared error for training, validation, and testing data for forty-three epochs for the second predictive model;

FIG. 10 is a parity plot of a validation dataset for the second predictive model;

FIG. 11 is a parity plot of a testing dataset for the second predictive model;

FIG. 12A is a regression plot for a training dataset for the second predictive model;

FIG. 12B is a regression plot for a validation dataset for the second predictive model;

FIG. 12C is a regression plot for a testing dataset for the second predictive model;

FIG. 12D is a regression plot for the training, validation, and testing datasets for the second predictive model;

FIG. 13 is a parity plot of a training dataset for a third predictive model;

FIG. 14 is a parity plot of a validation dataset for the third predictive model;

FIG. 15 is a flow chart for the development of a fourth predictive model;

FIG. 16 is a minimum mean square error plot for iterations in the development of the fourth predictive model;

FIG. 17 is a response plot for the fourth predictive model;

FIG. 18 is a parity plot of a validation dataset for the fourth predictive model;

FIG. 19 is a parity plot of a testing dataset for the fourth predictive model;

FIG. 20 is a graphical user interface output screen;

FIG. 21 is the graphical user interface output screen for data from a first scenario;

FIG. 22 is the graphical user interface output screen for data from a second scenario;

FIG. 23 is the graphical user interface output screen for data from a third scenario;

FIG. 24 is the graphical user interface output screen for data from a fourth scenario;

FIG. 25 is the graphical user interface output screen for data from a fifth scenario; and

FIG. 26 is the graphical user interface output screen showing a plot of concentration over time for a set of data.

### DETAILED DESCRIPTION

Various apparatuses or methods will be described below to provide an example of an embodiment of each claimed invention. No embodiment described below limits any claimed invention and any claimed invention may cover apparatuses and methods that differ from those described below. The claimed inventions are not limited to apparatuses and methods having all of the features of any one apparatus or method described below, or to features common to multiple or all of the apparatuses or methods described below. It is possible that an apparatus or method described below is not an embodiment of any claimed invention. Any invention disclosed in an apparatus or method described below that is not claimed in this document may be the subject matter of another protective instrument, for example, a continuing patent application, and the applicant(s), inventor(s) and/or owner(s) do not intend to abandon, disclaim or dedicate to the public any such invention by its disclosure in this document.

The teachings described herein relate to a system and method for indirectly monitoring an amine-based carbon capture solvent for deterioration (e.g., chemical degradation and/or differential evaporation). Measurements of properties of the amine-based carbon capture solvent are taken and used to predict a predicted concentration of a component of the amine-based carbon capture solvent for comparison to a desired concentration. The measurements may be taken while the amine-based carbon capture solvent is in a lean amine leading from a desorber of a solvent circulation system of a carbon capture plant.

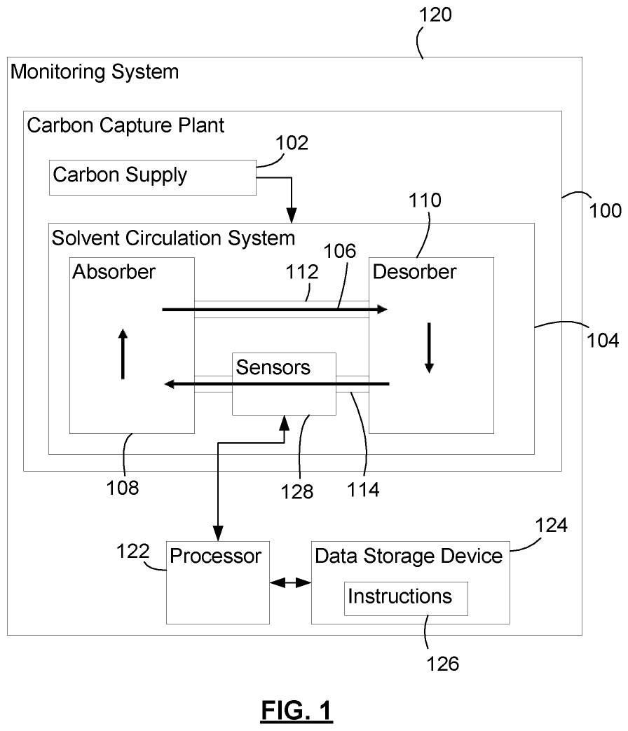

As exemplified in FIG. 1, a carbon capture plant 100 includes a carbon supply 102 supplying a gas to a solvent circulation system 104. The gas carries carbon (e.g., CO₂). The carbon supply 102 may be, e.g., a flue of a combustion plant such as a coal fired power plant. The solvent circulation system 104 circulates an amine-based carbon capture solvent 106. It will be appreciated that various amine-based carbon capture solvents may be used. In some embodiments, the amine-based carbon capture solvent 106 includes 2-Amino-2-Methyl-1-Propanol (AMP) and 2-(Dimethyl amino)-ethanol (DMAE).

The solvent circulation system 104 includes an absorber 108 and a desorber 110. In the absorber 108 the amine-based carbon capture solvent 106 is brought into contact with the gas and captures carbon from the gas. The cleaned gas may then be released from the solvent circulation system 104 (e.g., into the atmosphere). The gas may be cooled prior to being introduced into the absorber 108.

In the desorber, the amine-based carbon capture solvent 106 releases the captured carbon. It will be appreciated that the amine-based carbon capture solvent 106 may be heated in the desorber to facilitate release of the carbon. The carbon may be collected from the desorber for, e.g., compression and storage.

The solvent circulation system 104 includes a carbon rich amine path 112 from the absorber 108 to the desorber 110. The solvent circulation system 104 includes a lean amine path 114 back from the desorber 110 to the absorber 108. One or more paths may be a cooled path. For example, the lean amine path 114 may be a cooled lean amine path 114.

During operation of the carbon capture plant 100, the amine-based carbon capture solvent 106 may be at an elevated temperature relative to room temperature. For example, the amine-based carbon capture solvent 106 in the lean amine path 114 may be at an elevated temperature (e.g., due to the heating used in the desorber 110), even if the lean amine path is cooled. The elevated temperature may be more than 30° C., more than 35° C., or at least about 40° C. The elevated temperature may be between 35° C. and 100° C., between 35° C. and 80° C., or between about 40° C. and about 60° C.

Solvent deterioration may be due to physical changes occurring in the solvent where desired components of the solvent are at undesired concentrations due to differential evaporation of components of the solvent. For example, if the solvent includes water, the water may evaporate at a different rate than the amine. In some embodiments, the predicted concentration of the component includes a predicted amine concentration of an amine component of the amine-based carbon capture solvent 106.

Solvent deterioration may be due to a chemical degradation in which new products known as degradation products are formed. Degradation products have a noticeable impact on solvent properties, such as altering the physical and chemical properties of the solvent. In some embodiments, the predicted concentration of the component includes a predicted degradation product concentration of a degradation product component of the amine-based carbon capture solvent 106.

In some embodiments, the predicted degradation product concentration of the degradation product component includes a predicted ammonium or formate ion concentration of an ammonium formate component of the amine-based carbon capture solvent. In some embodiments, the predicted degradation product concentration of the degradation product component includes a predicted ammonium or acetate ion concentration of an ammonium acetate component of the amine-based carbon capture solvent.

As exemplified in FIG. 1, a system 120 for monitoring deterioration of the amine-based carbon capture solvent 106 includes at least one processor 122 and at least one data storage device 124. The at least one processor 122 is communicatively coupled to the at least one data storage device 124. The at least one data storage device 124 has computer-executable instructions 126 stored thereon for operating the at least one processor 122.

The instructions 126 include instructions to receive operational measurements of a plurality of properties of the amine-based carbon capture solvent 106 in the solvent circulation system 104 of the carbon capture plant 100 during operation of the carbon capture plant 100. In some embodiments, the system is integrated with and includes the carbon capture plant 100. In some embodiments, the operational measurements are provided from an external carbon capture plant.

As exemplified, the carbon capture plant 100 may include sensors 128 to capture the operational measurements (e.g., a plurality of sensors, such as a sensor for each operational measurement). As exemplified, the operational measurements of the amine-based carbon capture solvent 106 may be taken while the amine-based carbon capture solvent 106 is in the lean amine path 114. The sensors 128 may be arranged to measure the properties of the amine-based carbon capture solvent 106 while the amine-based carbon capture solvent 106 is in the lean amine path 114.

The operational measurements include a plurality of properties to provide sufficient information for the monitoring system 120 to detect a deterioration of the solvent. The plurality of properties of the amine-based carbon capture solvent 106 include a refractive index, a density, a viscosity, an ionic conductivity, a thermal conductivity, a heat capacity, an electrical conductivity, a surface tension, infrared (IR) radiation, and/or ultra violet (UV) radiation. In some embodiments, the plurality of properties of the amine-based carbon capture solvent 106 includes at least three properties. In some embodiments, the plurality of properties of the amine-based carbon capture solvent 106 includes at least four properties. In some embodiments, the plurality of properties of the amine-based carbon capture solvent 106 includes the refractive index, the density, the viscosity, and the ionic conductivity.

The computer-executable instructions 126 stored on the at least one data storage device 124 include instructions to apply a predictive model. The predictive model may be a regression model. The predictive model may include a machine learned model. The predictive model may include a trained artificial neural network.

The instructions 126 include instructions to apply the predictive model to the operational measurements to generate a predicted concentration. The predicted concentration is a prediction of a concentration of a component of the amine-based carbon capture solvent 106. The concentration of the component is predicted using the predictive model (e.g., indirectly monitored), rather than being directly measured.

The instructions 126 include instructions to determine a difference between the predicted concentration and a desired concentration of the component. The instructions 126 include instructions to generate a deterioration detection event (e.g., a chemical degradation and/or evaporation detection event) if the difference is greater than a predetermined threshold.

The monitoring system may monitor the concentration of one component or of more than one component of the amine-based carbon capture solvent 106 (e.g., monitoring the concentration of two or more components independently or together). Where the concentration of more than one component is monitored, the monitoring system may use a common model to determine the predicted concentrations of each of more than one component of the solvent. However, in some embodiments the monitoring system uses more than one predictive model. The monitoring system may apply a first predictive model for a predicted concentration of a first component and a second, different predictive model for a second component. For example, the monitoring system may apply a first predictive model to determine a predicted concentration of an amine component of the amine-based carbon capture solvent and a second predictive model to determine a predicted concentration of a degradation product component of the amine-based carbon capture solvent. The first predictive model may be based on data related to the first component and the second predictive model may be based on data related to the second component. For example, the first predictive model may be a machine learned model trained on amine concentration data and the second predictive model may be a machine learned model trained on degradation product data.

The instructions 126 may include instructions to determine a difference between the predicted concentration and a desired concentration for each of the plurality of monitored components. The instructions 126 may include instructions to generate a deterioration detection event (e.g., a chemical degradation and/or evaporation detection event) if the difference of any one of the monitored components is greater than a predetermined threshold. The deterioration detection event may indicate which one or ones of the monitored components caused the event.

The deterioration detection event may include an alert, such as a visual alert (e.g., a light turning on or changing color) or an audible alert (e.g., a warning chime or ongoing alarm). The deterioration detection event may include a log entry, such as noting the event in a monitoring log file for subsequent review. The deterioration detection event may include an automated remediation action, such as automatically implementing a suggested remediation action as described further below (with or without first presenting the suggested remediation action to a user).

The instructions may include instructions to determine a possible cause of the deterioration (e.g., a cause of the chemical change (degradation) and/or physical change (evaporation)). For example, a cause option may be the evaporation of the component for which the concentration was predicted, or of another component. The cause option may be the evaporation of water if the predicted amine concentration is higher than the desired amine concentration. The possible cause may be selected from a set of cause options stored on the at least one data storage device 124. The possible cause determination may be selected in any suitable way, such as by a table look up, machine learned aspects of the model that determined the predicted concentration, or another machine learned model.

In some embodiments, the computer-executable instructions 126 stored on the at least one data storage device 124 include instructions for operating the at least one processor 122 to determine a suggested remediation action to adjust the predicted concentration towards the desired concentration. For example, a remediation option may be to add an amount of a component that has a concentration below a desired amount, or to add an amount of one component to decrease the concentration of another component. The remediation option may be to add water if the amine concentration is too high. As another example, a remediation action may be to perform a solvent reclaiming operation, such as when a concentration of a degradation product or a sum of the concentrations of multiple degradation products is too high. The suggested remediation action may be selected from a set of remediation options stored on the at least one data storage device 124. The suggested remediation action may be selected in any suitable way, such as by a table look up, machine learned aspects of the model that determined the predicted concentration, or another machine learned model.

The monitoring system 120 may periodically receive and analyze new measurements as described above by applying a predictive model and comparing the predicted concentration to a desired concentration. For example, the monitoring system 120 may receive and analyze new measurements on a predetermined schedule, such as at least once a day, at least once an hour, or at least once a minute. Receiving new measurements may occur at evenly-spaced intervals, e.g., spaced by a day, an hour, or a minute. Accordingly, the monitoring system 120 may monitor the amine-based carbon capture solvent on an ongoing basis, e.g., until a deterioration detection event is generated or continually until turned off even if a deterioration detection event is generated.

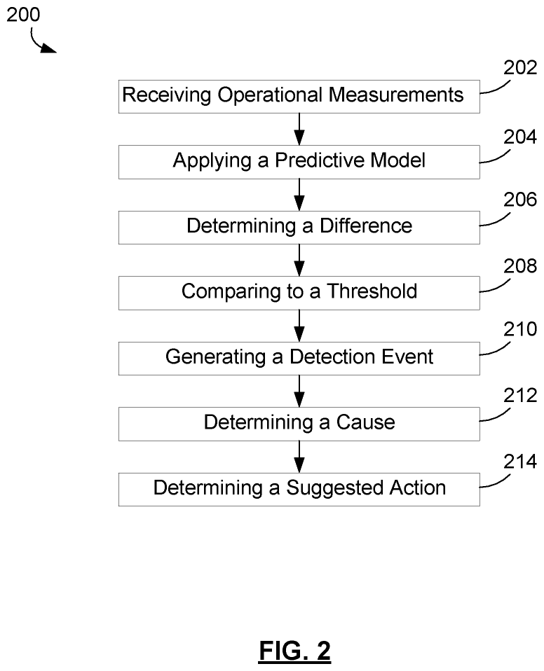

FIG. 2 illustrated a flow chart of a method 200 of detecting deterioration of an amine-based carbon capture solvent. The method 200 may be a computer implemented method, such as implemented by at least one processor (e.g., the at least one processor 122, discussed elsewhere herein).

Method 200 includes, at step 202, receiving operational measurements of a plurality of properties (e.g., the properties discussed elsewhere herein) of an amine-based carbon capture solvent (e.g., solvent 106, discussed elsewhere herein) in a solvent circulation system of a carbon capture plant during operation of the carbon capture plant. The operational measurements may be captured from the amine-based solvent while the amine-based carbon capture solvent is in a lean amine path (e.g., lean amine path 114, discussed elsewhere herein) from a desorber of the solvent circulation system.

Method 200 includes, at step 204, applying a predictive model to the operational measurements to generate a predicted concentration. The predicted concentration is a prediction of a concentration of a component of the amine-based carbon capture solvent. The predictive model may be any of the predictive models discussed elsewhere herein.

Method 200 includes, at step 206, determining a difference between the predicted concentration and a desired concentration. At step 208, method 200 includes determining that the difference is outside a predetermined threshold. At step 210, method 200 includes generating a deterioration detection event in response to determining that the difference is outside the predetermined threshold. It will be appreciated that the method may include monitoring more than one component as discussed elsewhere herein. It will be appreciated that steps 202, 204, and 206 may be performed continually, such as described elsewhere herein with respect to the monitoring system 120.

Method 200 may include, at step 212, determining a possible cause of the deterioration. Method 200 may include, at step 214, determining a suggested remediation action to adjust the predicted concentration towards the desired concentration.

Fouling, foaming, corrosion, solvent loss, the generation of volatile chemicals that could be hazardous to the environment, and other operational issues in carbon capture plants have also been linked to solvent deterioration. For example, the amine-based carbon capture solvent could undergo modifications due to the occurrence of foaming, corrosion and emission which would affect its properties.

### EXAMPLES

The following non-limiting examples are illustrative of the present application:

### Experimental Setup

The solvent used was a 4M (1:1) bi-blend of 2-Amino-2-Methyl-1-Propanol (AMP) and 2-(Dimethyl amino)-ethanol (DMAE). The 2-Amino-2-Methyl-1-Propanol (BioXtra grade with ≥95% purity) and the 2-(Dimethyl amino)-ethanol (≥99.5% purity) were obtained from Sigma-Aldrich Canada™.

Also used was ammonium formate (Reagent grade, 97% purity) obtained from Sigma-Aldrich Canada™, ammonium acetate (ACS Reagent grade, ≥97% purity) obtained from Sigma-Aldrich Canada™, carbon dioxide (CO₂) obtained from Linde Canada™, and 1N hydrochloric acid (HCl) solution obtained from Fisher Scientific Canada™.

Refractive index was measured using an Abbemat 550™ digital refractometer from Anton Paar™, with an accuracy of ±0.00002 nD. Density was measured using DMA 4500 M™ density meter from Anton Paar™, with accuracy of 0.00001 g/cm³ for density and 0.01° C. for temperature. Lovis 2000 M/ME™ rolling-ball micro viscometer from Anton Paar™, with accuracy of 0.5% for viscosity and 0.02° C. for temperature was employed in the measurement of the solvent viscosity. Ionic conductivity was measured using Traceable™ Conductivity/TDS pen obtained from Cole Parmer™.

Before sample measurements, a water test was run to ensure accurate results from the instruments using degassed deionized water. All measurements were triplicated and the average measured value recorded.

The relationship between the physical and chemical changes and solvent properties can be correlated using statistical methods or machine learning. Both approaches were used to correlate data and develop predictive models.

### Example 1—Physical Change

The following is directed to differential evaporation of the components of the solvent with time or the dilution of the solvent in an attempt to restore its concentration.

To mimic physical change which could result in change of concentration of the solvent, the solvent was prepared in different concentrations of 3M, 3.5M, 4M, 4.5M and 5M considering different ratios of AMP and DMAE (1:1, 1.5:2, 2:1.5, 2:2.5, 2.5:2) with CO₂ loading ranging from 0.1 to 0.5 mol CO₂/mol amine at intervals of 0.1. The properties of these different solvents prepared were then measured at temperatures of 40° C., 50° C. and 60° C. These conditions were selected in order to mimic the conditions of a real operating capture plant considering amine sampling points for measurements along the cooled lean amine stream from the desorber.

Three regression predictive models were developed, using, respectively, MS Excel™, Minitab™, and artificial neural network (ANN) in MATLAB™, assuming a linear relationship between the predictor and response variables. These predictive models were developed to predict the concentration of the solvent using solvent properties in order to determine if a physical change (water evaporation or dilution) had occurred based on the solvent properties measured. The performance of the models in terms of accurately predicting the experimental concentration was evaluated using average percentage absolute deviation (AAD) given by the formula below:

$$AAD = \frac{{\sum }_{1}^{n} \vert \frac{{x}_{experimental} - {x}_{predicted}}{{x}_{predicted}} \vert}{n} * 100 \%$$

The regression predictive model with MS Excel™ was trained using the linear regression tool in the Data Analysis section in MS Excel 2016™. The regression returned an R square value of 0.97, indicating a good correlation between the predictor and response variables. The standard error associated with the model was 0.097, indicative of a good model.

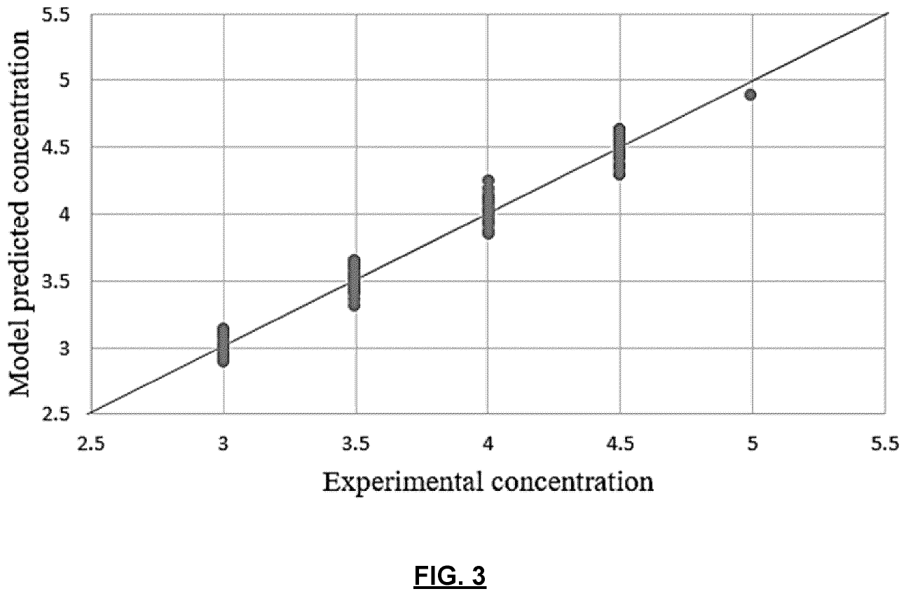

The predicted concentration of the training set from the regression predictive model with MS Excel™ as compared to the experimental concentration yielded an average absolute deviation (AAD) of 2.09%, as seen in FIG. 3.

Based on the coefficients obtained, a model equation was developed for the prediction of the solvent concentration as follows, where A, B, C and D are the refractive index, density (g/ml), viscosity (mPa·s) and ionic conductivity (mS) of the solvent respectively:

$$Solvent concentration ( M ) = 86. 85 A - 19.29 B - 0.019 C + 0.00613 D - 96.56$$

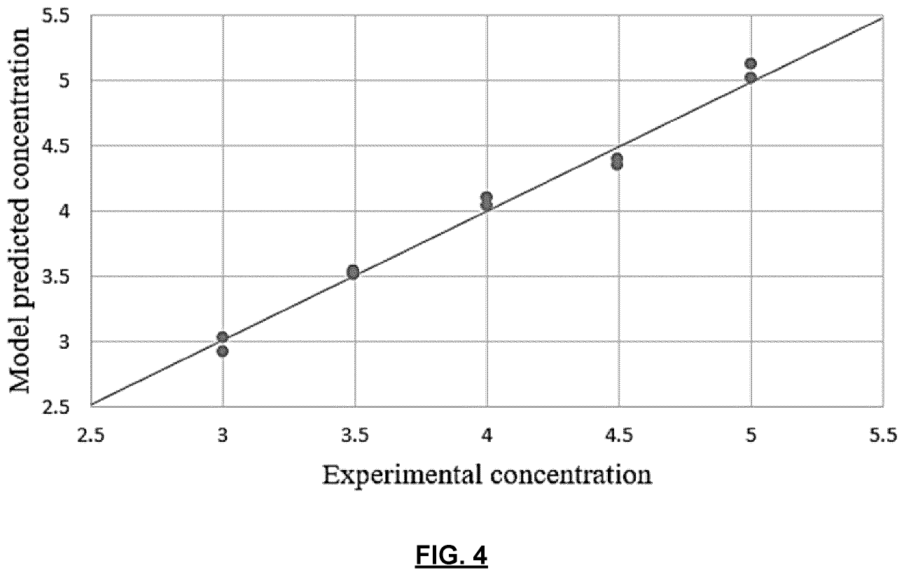

The regression predictive model with MS Excel™ was validated in order to test the performance of the model on unseen data. FIG. 4 shows a parity plot of the model predicted concentration against the experimental concentration with an average absolute deviation (AAD) of 1.56%, indicating very good predictive ability of the model developed.

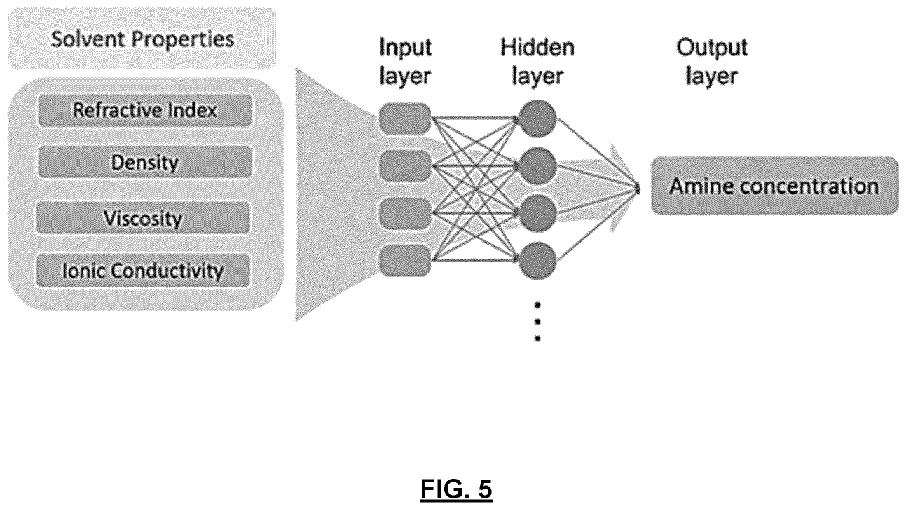

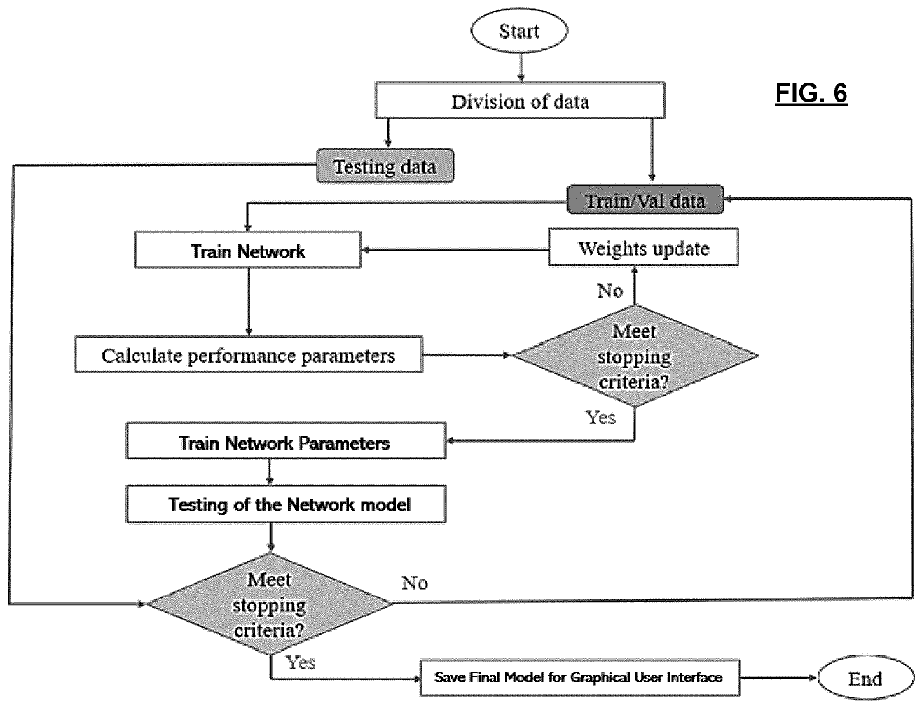

The second predictive model was an artificial neural network model developed using MATLAB™, and was developed using the same predictor and response variables used for the regression predictive model with MS Excel™. A 2-layer feed-forward neural network with 6 neurons in the hidden layer along with trainIm™, a training function that updates weights and bias values based on the Levenberg-Marquardt back propagation algorithm, was used to train the network. A pictorial view of how the network was trained using the solvent properties to predict the concentration is captured in FIG. 5. The model was developed using the flowchart found in FIG. 6.

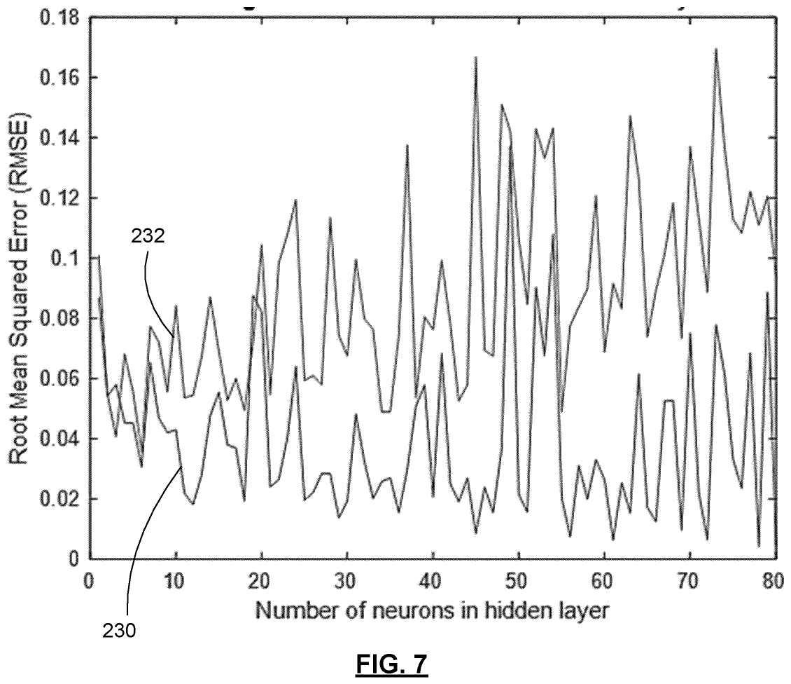

FIG. 7 shows a plot of the root mean squared error vs. the number of neurons used in the hidden layer for the training dataset 230 and the validation dataset 232. The optimum number of neurons for the artificial neural network predictive model with the minimum root mean squared error for both training and validation datasets was found to be six, and was used to train the final artificial neural network predictive model.

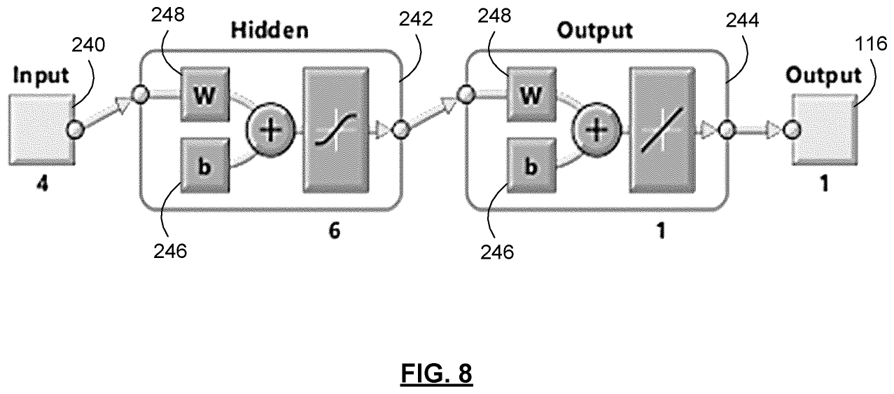

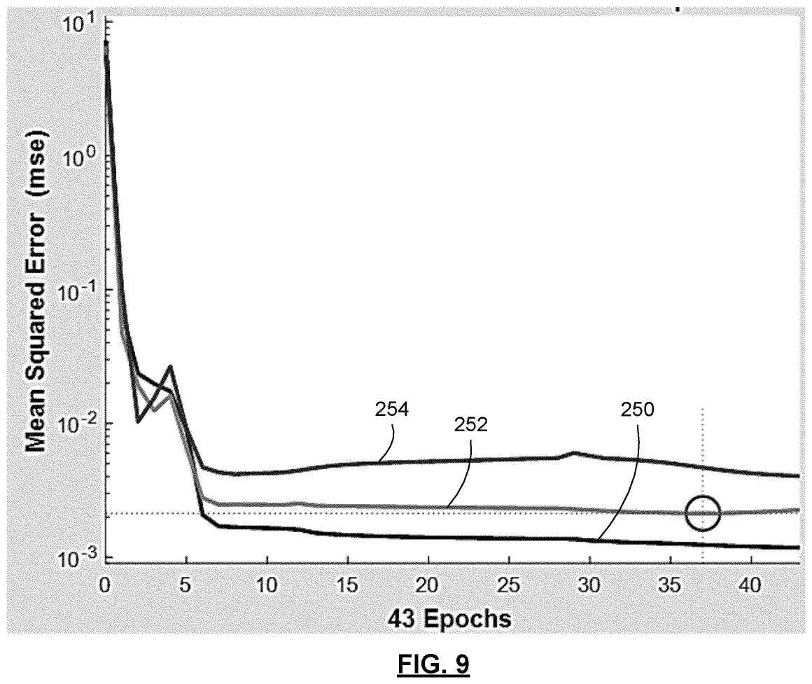

The network architecture can be seen in FIG. 8. The network includes four input neurons 240, six hidden layer neurons 242, and 1 output layer neuron 244. As illustrated, neurons include a bias unit 246 and a weight 248 trained to produce the correct output. The artificial neural network predictive model was trained with 43 epochs. In FIG. 9, the best validation performance is seen to occur at epoch 37 which recorded the lowest validation mean squared error (MSE) of 0.0021. FIG. 9 illustrates the mean squared error for a training dataset at 250, a validation dataset at 252, and a testing dataset at 254.

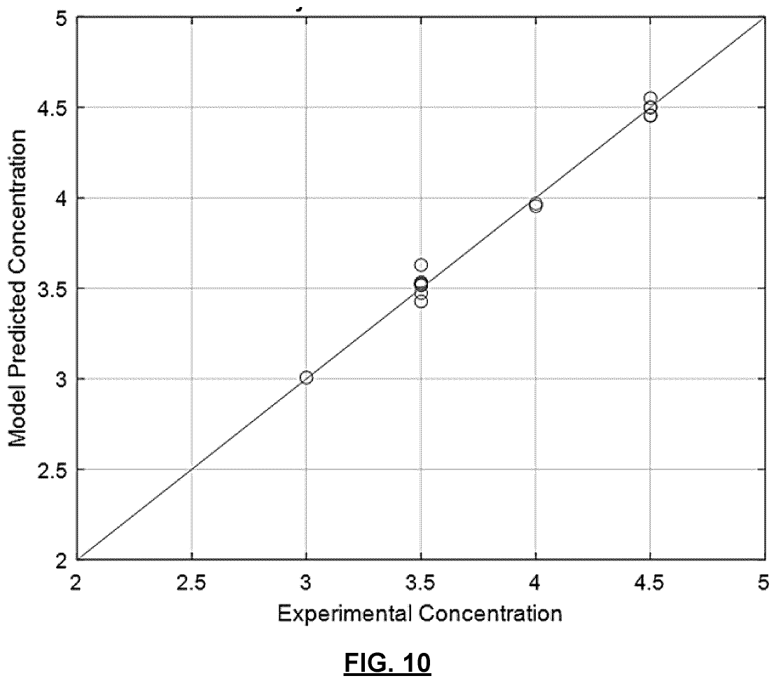

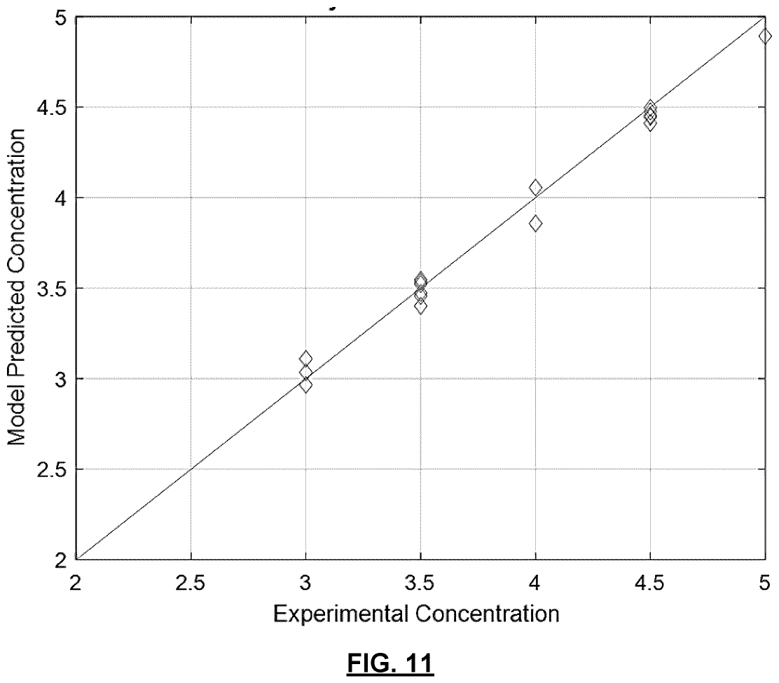

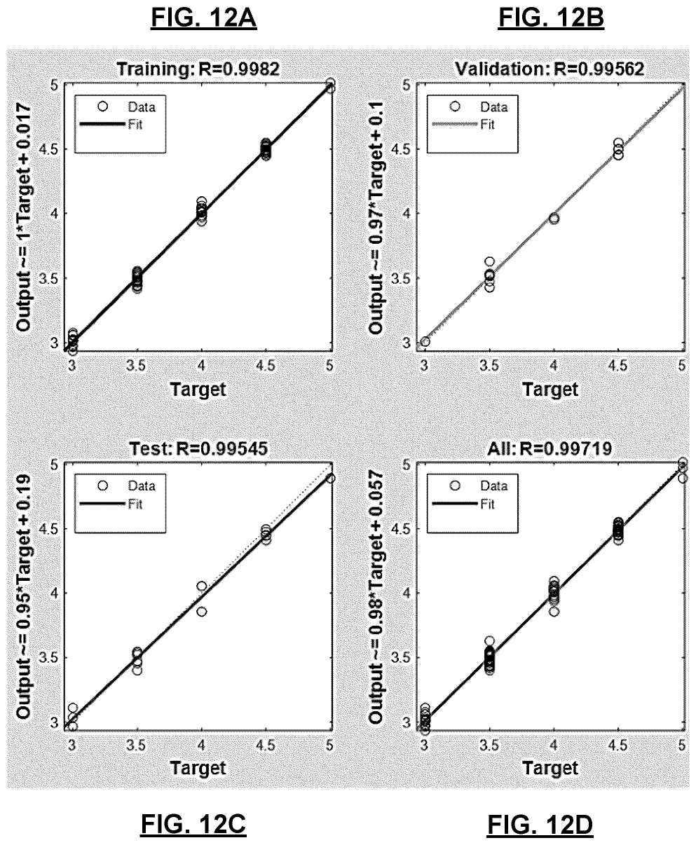

The root mean squared error of the validation data set for the artificial neural network predictive model was obtained to be 0.046 and that of the training set was 0.035. Again, the data reserved for testing the network resulted in root mean squared error of 0.068, signifying that the network was able to generalize very well, a feature which was very much desired. Parity plots of the predictive model predicted concentration against the experimental values for both validation and test dataset returned average absolute deviation of 0.91% and 1.47% respectively and are shown in FIG. 10 and FIG. 11. R-square values for training, validation, test and overall were obtained to be 0.998, 0.996, 0.995 and 0.997 respectively as seen in FIGS. 12A to 12D, showing good correlation between predictor and response variables.

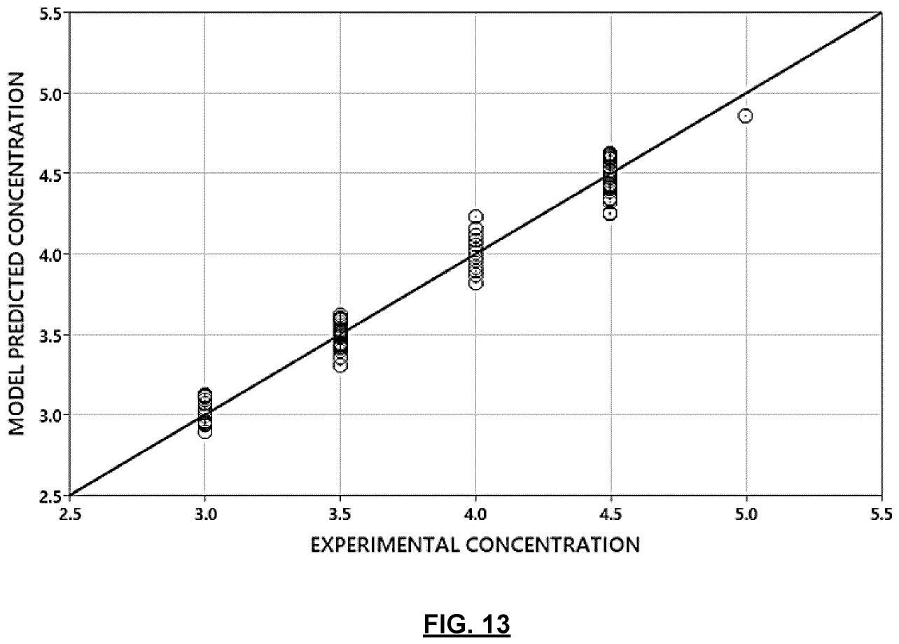

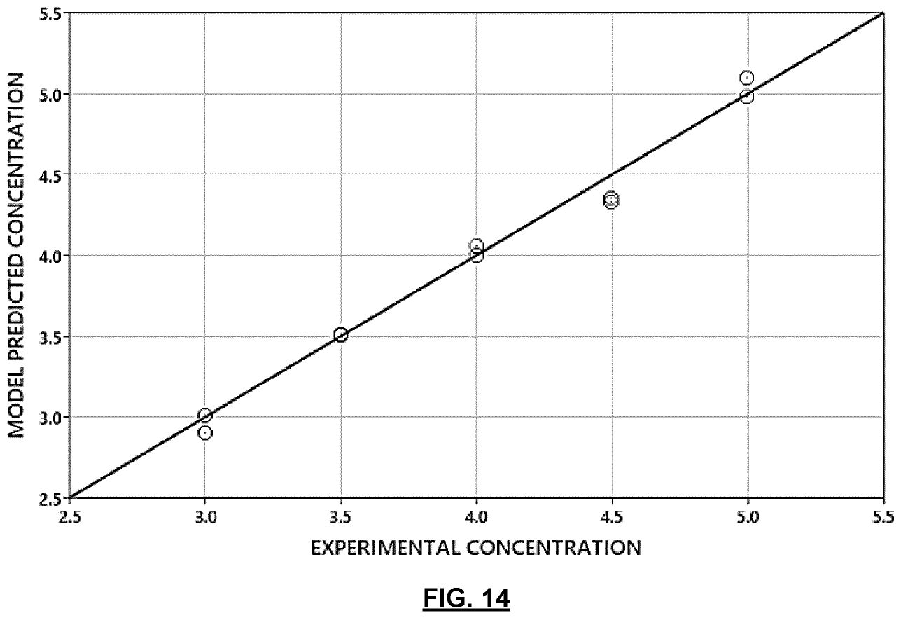

The third predictive model was developed with the same set of variables using the linear regression tool in the statistics section of the Minitab 2019™ software. The standard error associated with the trained model was 0.09 with R-squared value of 97.69% showing good performance and good correlation between predictor and response variables respectively. The standard error of the test set was 0.11 and R-squared value of 95.33%. FIG. 13 and FIG. 14 show the parity plot of the Minitab™ predictive model predicted concentration and experimental concentration of the training and validation datasets, respectively, with average absolute deviation of 2.07% and 1.39% respectively.

The model equation proposed by the Minitab software was given as follows, where A, B, C and D are the refractive index, density (g/ml), viscosity (mPa·s) and ionic conductivity (mS) of the solvent respectively:

$$Solvent concentration ( M ) = 84.74 A - 1 9.95 B + 0.0023 C + 0.00669 D - 93.09$$

The results of the three predictive models developed for physical changes is shown in Table 1, below:

TABLE 1

| | | Root Mean | Average Absolute |
|---|---|---|---|
| | | Squared Error | Deviation |
| | R² (%) | (RMSE) | (AAD %) |
| MS Excel ™ | 97.15 | Training: 0.09 | Training: 2.09 |
| predictive | | Validation: 0.08 | Validation: 1.56 |
| model | | | |
| Minitab ™ | 97.69 | Training: 0.09 | Training: 2.07 |
| predictive | | Validation: 0.08 | Validation: 1.39 |
| model | | | |
| ANN ™ | Training: 99.82 | Training: 0.04 | Training: 0.71 |
| predictive | Validation: 99.56 | Validation: 0.05 | Validation: 0.91 |
| model | Test: 99.55 | Test: 0.07 | Test: 1.47 |

As may be seen from Table 1, the artificial neural network (ANN) predictive model was the best performing predictive model of the three developed. This model was therefore used in the development of a graphical user interface (GUI) for physical change prediction, as described elsewhere herein.

### Example 2—Chemical Change

For chemical change experiments (i.e., the appearance of degradation products) the solvent was synthetically degraded by intentionally adding degradation products at different concentrations and measuring the new solvent properties at temperatures of 40° C., 50° C. and 60° C. and lean CO₂ loading of 0.1 mol CO₂/mol amine.

Because the work was geared towards early detection of solvent deterioration, only primary degradation products (formate and acetate) were used to degrade the solvent at very small concentrations (300 mg/L, 600 mg/L, 900 mg/L, 1200 mg/L and 1500 mg/L) as these products were likely to form first. NH₄⁺ ions were also introduced as part of the primary degradation products. Specifically, ammonium formate and ammonium acetate were the chemicals used as degradation products in this experiment.

A predictive model was developed to predict the concentration of primary degradation products in the solvent based on the solvent properties measured.

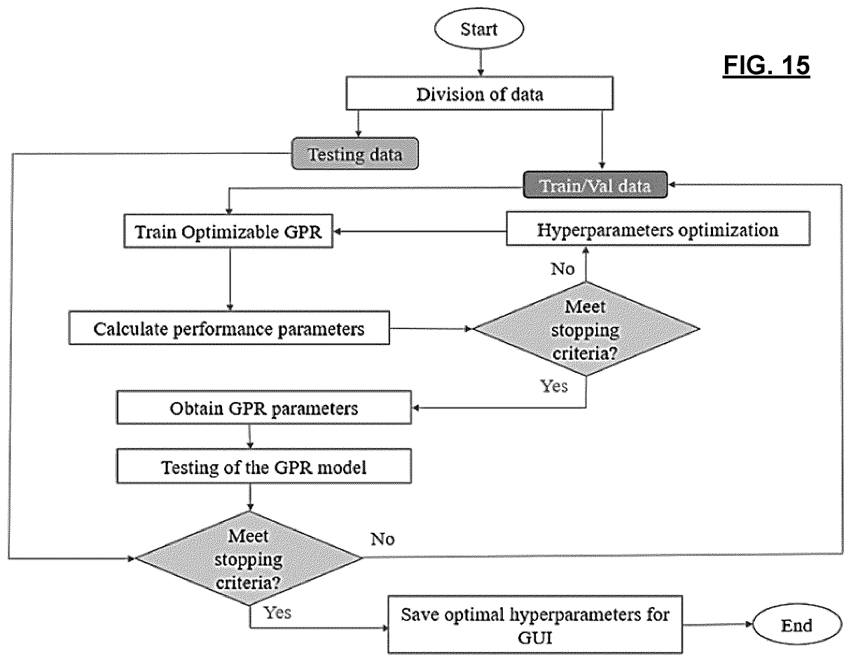

An Optimizable Gaussian Process Regression (GPR) model was trained using the Regression Learner™ tool in the Statistics and Machine Learning Toolbox™ in MATLAB™ software with 10-fold cross-validation and later exported to make predictions on new data. Bayesian optimization was employed for the training of the model with 30 iterations and training time of 95.772 seconds. FIG. 15 shows the flowchart of the predictive model developed for chemical change.

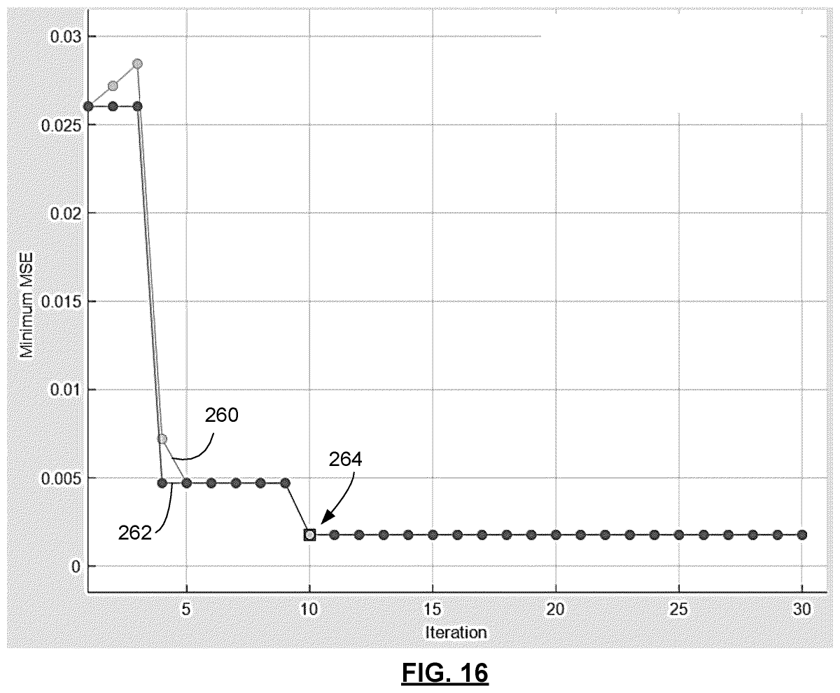

The optimized hyperparameters for the best model were constant basis function, non-isotropic matern 3/2 kernel function, a kernel scale of 0.0037536 selected from a search range of 0.00371-3.71 and a sigma value of 0.00010153 selected from a search range of 0.0001-5.2309 with standardization. The model with the best point and minimum mean squared error (MSE) hyperparameters was attained at the 10th iteration as shown in FIG. 16, showing a plot of the estimated minimum mean squared error 260 and the observed minimum mean squared error 262 with a minimum error hyperparameters location 264 at the 10^{th} iteration.

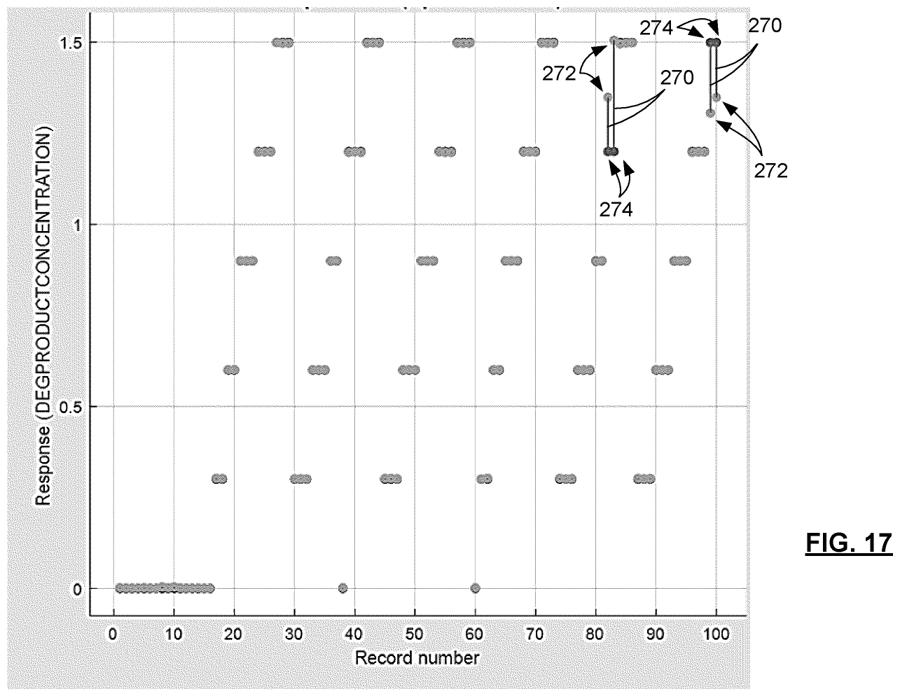

An initial evaluation of the predictive accuracy of the model involved using the trained model to predict the response variables from the training dataset and comparing the output of the model to the true values. The response plot generated in FIG. 17 showed a very good performance of the model in terms of predicting the output of the data it was trained with. The predicted output from the model coincided with the true values, shown by overlapping data points, except for some few data points in which errors 270 exist between predicted values 272 and true values 274. This shows very good predictability of the trained predictive model.

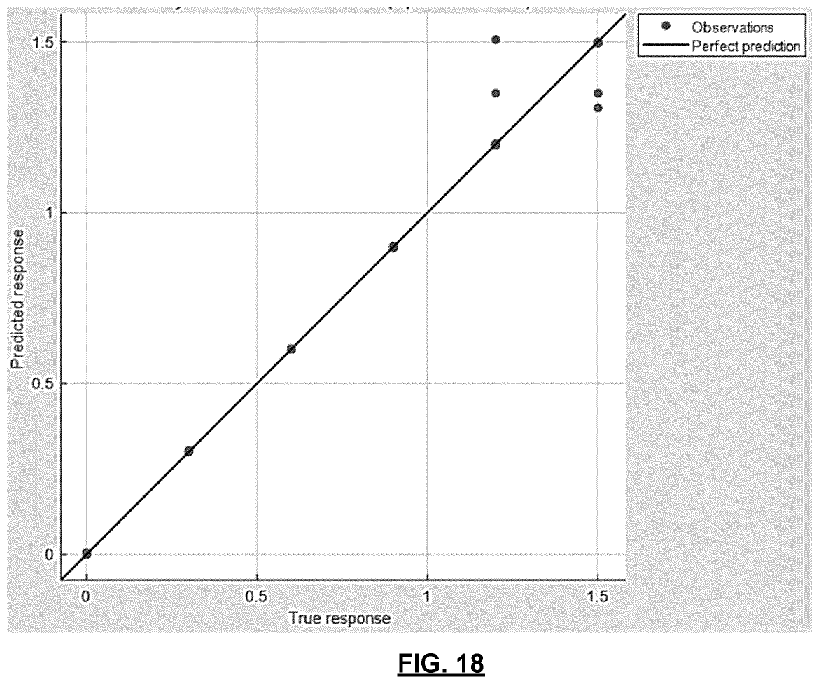

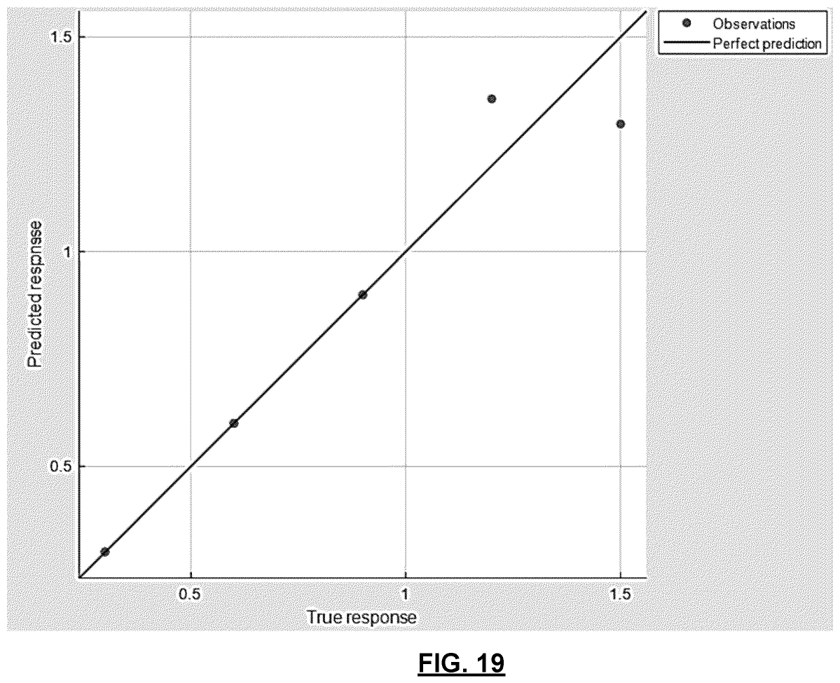

The trained predictive model returned an R-squared value of 0.99 for the validation set with a root mean squared error of 0.042, showing good correlation between predictor and response variables and good performance respectively. Additional eight data points were used to further test the performance of the model on unseen data which returned an R-squared value of 0.95 and RMSE of 0.090 showing the model's ability to make accurate predictions on unseen data. FIG. 18 and FIG. 19 show parity plots of the model output against the true values for the validation and test set, respectively. The average absolute deviation for the test set parity plot was computed to be 3.45%.

### Graphical User Interface Development

To make predictions and control easy for end users, an interactive graphical user interface (GUI) was designed using App Designer™ in MATLAB™.

The GUI was designed based on the predictive models developed to take user inputs, use the predictive models to make predictions using callback functions and return predicted values as output to the user. The GUI was designed to make predictions, interpret predicted values for the user and suggest actions that would enable the user to offset any disturbance or deviation from set values.

For early detection of amine degradation, a target value of the concentration of primary degradation products was set beyond which the interface would prompt end users and suggest ways to offset such deviations from the set value in the system such as solvent reclaiming. The GUI designed in this work is an example for degradation and also applies to other challenges such as foaming, emission and corrosion.

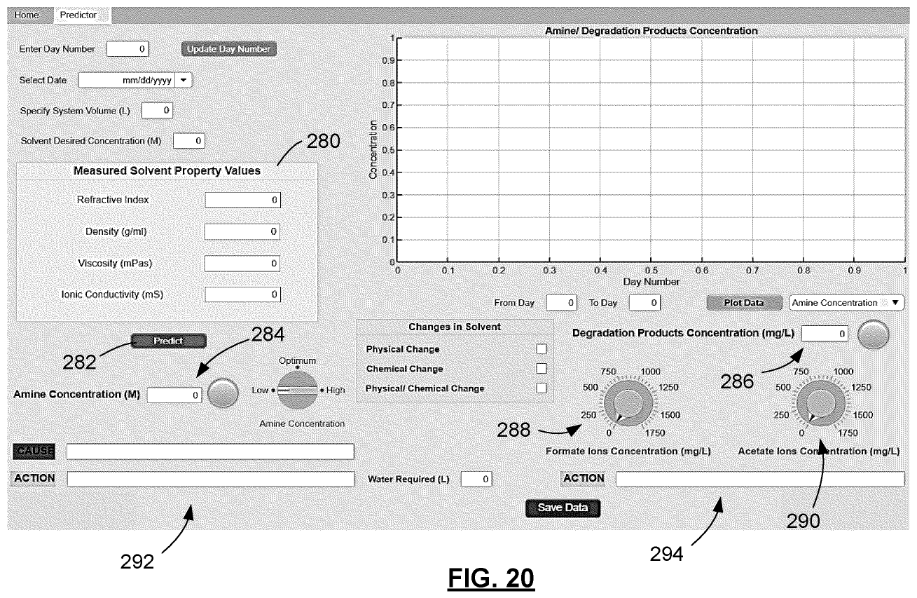

FIG. 20 shows a prediction tab with the various features that the user can take advantage of depending on the task at hand. It features a solvent property tab 280 where the user can enter measured solvent properties for prediction. It will be appreciated that in some embodiments these values may be entered automatically, such as directly from a communicatively coupled sensor. When clicked, the predict button 282 employs the predictive models developed (e.g., employs one physical change predictive model and one chemical change predictive model) to make predictions for the amine concentration at output 284 as well as for the degradation products concentration at output 286 and displays the values on the screen for the user. The predicted concentration of the degradation products may be a sum of all monitored products (e.g., to compare to a threshold amount for the grouping of all monitored products) and/or may be broken down by type of degradation product, such as at outputs 288 and 290 for formate and acetate ions respectively. It will be appreciated that the determination of a deterioration detection event may be based on either the sum of all monitored degradation products or determined separately for each monitored degradation product, depending on how the system is set up. Depending on the predicted values, the GUI can suggest ways of offsetting any deviations in amine concentration at output 292 and/or ways of offsetting deviations in degradation product concentration at output 294, e.g., based on the different scenarios employed in its development.

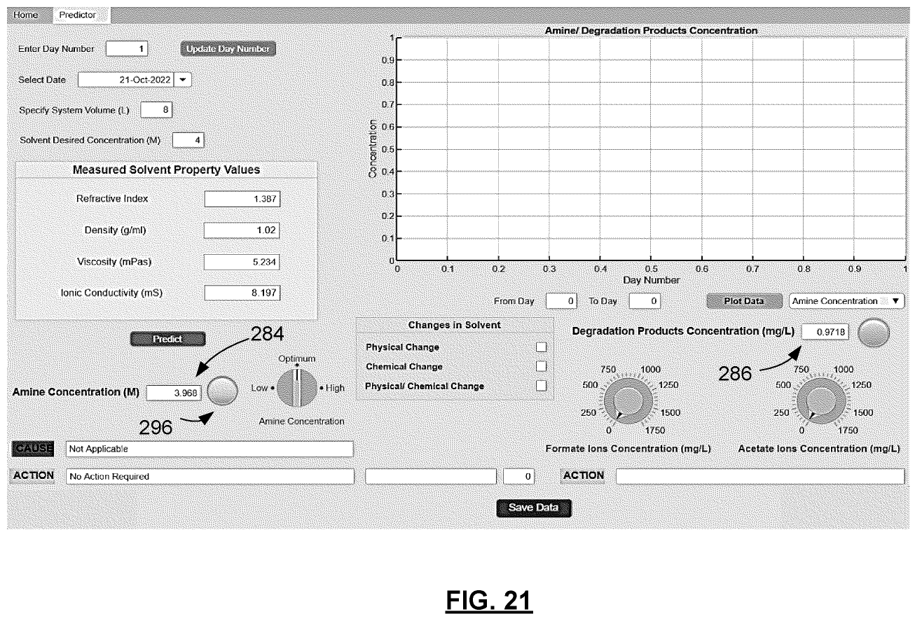

For instance, in scenario 1, as can be seen in FIG. 21, the combination of solvent properties shows at output 284 that the amine concentration falls within the optimum range and shows at output 286 that no degradation products are detected. An alert or output 296, in this case a warning lamp, therefore indicates that there is no action required from the user (e.g., the lamp turns green).

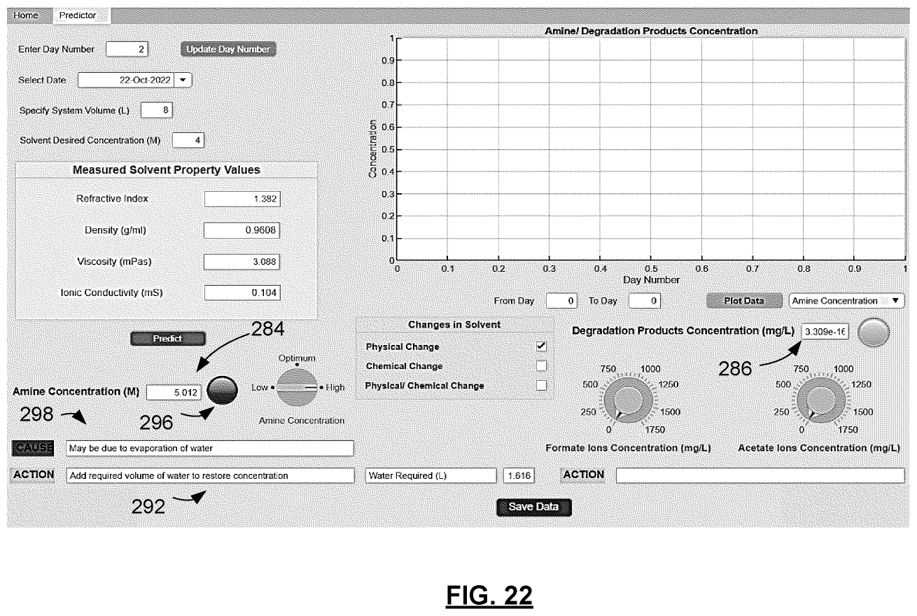

FIG. 22 shows scenario 2, wherein the predicted amine concentration shown at output 284 is high while it is shown at output 286 that no degradation products are detected, indicating the occurrence of a physical change only (e.g., differential evaporation). The alert 296 therefore indicates a deviation (e.g., turns red) and the application provides a suggestion at output 298 of what kind of change may have taken place, and offers at 292 a suggested remedy to offset this change.

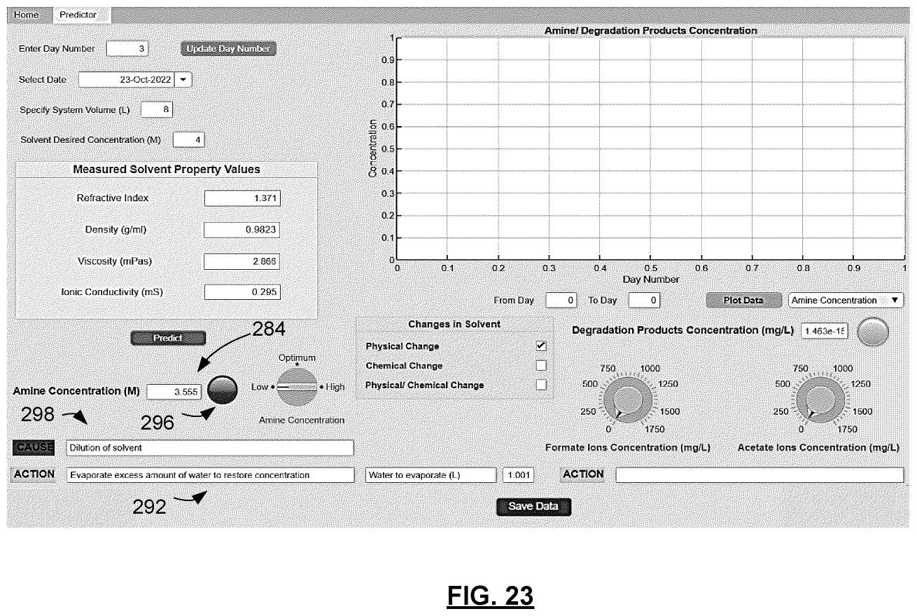

Similar to scenario 2, scenario 3 also shows in FIG. 23 at output 284 the occurrence of a physical change. However, the amine concentration predicted is rather lower than optimum, indicating the possibility of system dilution as indicated at output 298. At output 296 the GUI alerts the user of this change and at output 292 the GUI suggests ways of restoring the system to optimum conditions.

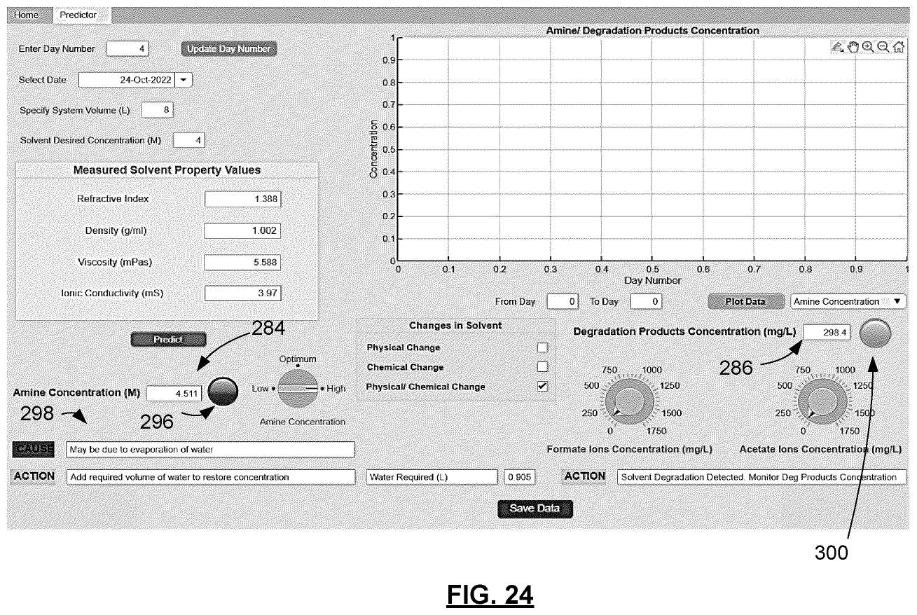

Scenario 4 shows the occurrence of both physical and chemical change as can be seen in FIG. 24, at output 284 and output 286, respectively. The GUI alerts the physical change at output 296 and suggests at output 298 that evaporation of water may have caused the physical change, and suggests via alert 300 that a chemical change is also occurring. However, the degradation products concentration detected is below the setpoint and therefore the alert for chemical change 300 is a warning (e.g., the lamp turns orange), telling the user to keep an eye on the degradation products concentration while restoring the amine concentration to normal.

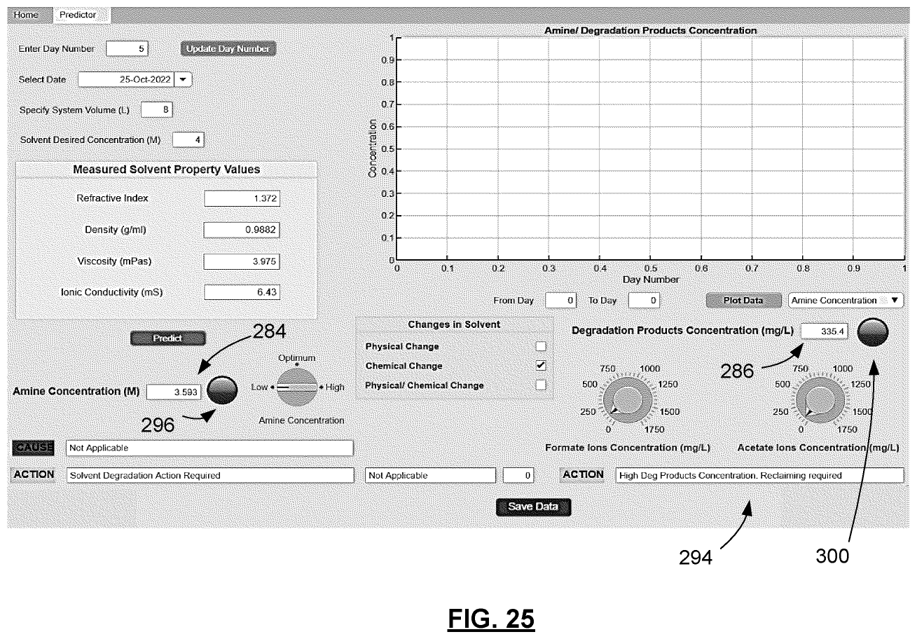

Scenario 5, as shown in FIG. 25 shows at output 286 the occurrence of a chemical change which results in a lower amine concentration. The amine concentration detected is below a setpoint, as shown at alert 296. The degradation products concentration detected in this scenario exceeds the setpoint, as shown at alert 300. Therefore, both alerts 296 and 300 indicate an action is required (e.g., turn red). The GUI suggests, at output 294, amine reclaiming to reduce the degradation products concentration.

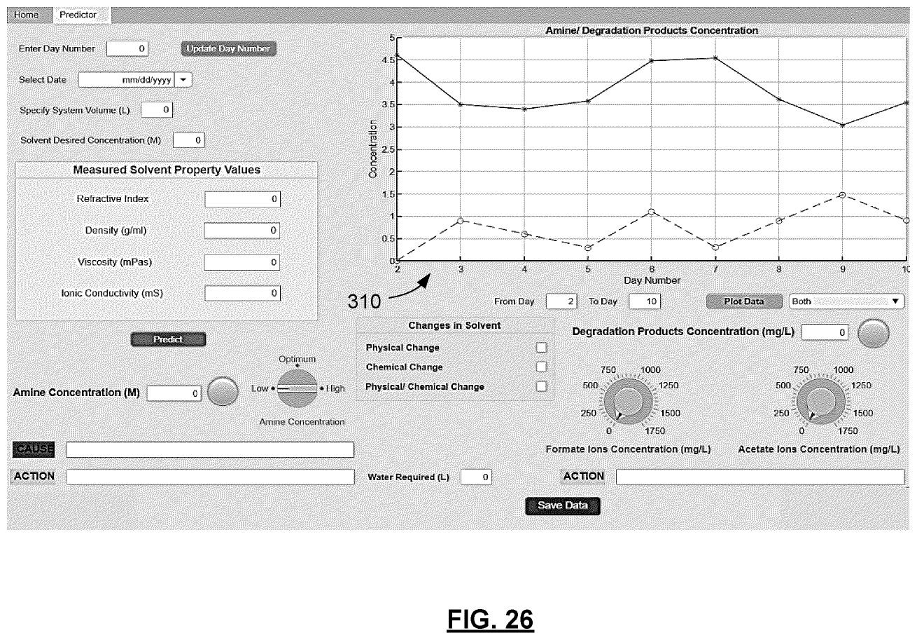

FIG. 26 shows the graphical feature of the GUI at 310. This allows the user to plot a history of amine concentration, degradation products concentration or both to help in analysis and decision making. The setpoint for the degradation products concentration allows the user to detect amine degradation as early as possible and therefore is able to reduce or altogether eliminate its impact on the solvent performance and overall capture process.

From the above it may be seen that three reliable models were developed using three different modeling tools to predict the occurrence of physical changes such as evaporation or dilution of solvent during the CO₂ capture process. A machine learning model with the capability of predicting and early detecting degradation product concentrations during the capture process was also developed. Additionally, a graphical user interface was developed to employ these models in making predictions and suggesting ways of restoring the solvent to its original state.

What has been described above has been intended to be illustrative of the invention and non-limiting and it will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

1. A system for monitoring for deterioration of an amine-based carbon capture solvent, comprising:
a. at least one processor;
b. at least one data storage device communicatively coupled to the at least one processor, the at least one data storage device having stored thereon computer-executable instructions for operating the at least one processor to:
i. receive operational measurements of a plurality of properties of the amine-based carbon capture solvent in a solvent circulation system of a carbon capture plant during operation of the carbon capture plant;
ii. apply a predictive model to the operational measurements to generate a predicted concentration, the predicted concentration being a prediction of a concentration of a component of the amine-based carbon capture solvent; and
iii. generate a deterioration detection event in response to determining that a difference between the predicted concentration and a desired concentration is outside a predetermined difference threshold.

2. The system of claim 1, wherein the computer-executable instructions include instructions for operating the at least one processor to determine a remediation action to adjust the predicted concentration towards the desired concentration, the remediation action selected from a set of remediation options stored on the at least one data storage device.

3. The system of claim 1 or claim 2, wherein the system further comprises the carbon capture plant, the carbon capture plant including a plurality of sensors arranged to generate the operational measurements, the plurality of sensors arranged to measure the plurality of properties of the amine-based carbon capture solvent while the amine-based carbon capture solvent is in a lean amine path from a desorber of the solvent circulation system to generate the operational measurements.

4. The system of any one of claims 1 to 3, wherein the predicted concentration of the component includes a predicted amine concentration of an amine component of the amine-based carbon capture solvent.

5. The system of any one of claims 1 to 4, wherein the predicted concentration of the component includes a predicted degradation product concentration of a degradation product component of the amine-based carbon capture solvent.

6. The system of claim 5, wherein the predicted degradation product concentration of the degradation product component includes a predicted ammonium ion or formate ion concentration of an ammonium formate component of the amine-based carbon capture solvent or a predicted ammonium ion or acetate ion concentration of an ammonium acetate component of the amine-based carbon capture solvent.

7. The system of any one of claims 1 to 6, wherein the plurality of properties is selected from a group of properties including a refractive index, a density, a viscosity, an ionic conductivity, a thermal conductivity, a heat capacity, an electrical conductivity, a surface tension, an infrared (IR) radiation, or an ultra violet (UV) radiation.

8. The system of any one of claims 1 to 7, wherein the plurality of properties includes a refractive index, a density, a viscosity, and an ionic conductivity.

9. The system of any one of claims 1 to 8, wherein the predictive model is a regression model.

10. The system of any one of claims 1 to 8, wherein the predictive model incudes a trained artificial neural network.

11. The system of any one of claims 1 to 10, wherein the operational measurements are measurements of the amine-based carbon capture solvent when the amine-based carbon capture solvent is at a temperature greater than 35° C.

12. A system for monitoring for deterioration of an amine-based carbon capture solvent, comprising:
a. at least one processor;
b. at least one data storage device communicatively coupled to the at least one processor, the at least one data storage device having stored thereon computer-executable instructions for operating the at least one processor to:
i. receive operational measurements of a plurality of properties of the amine-based carbon capture solvent in a lean amine path from a desorber of a solvent circulation system of a carbon capture plant during operation of the carbon capture plant while the amine-based carbon capture solvent is at a temperature of at least 35° C.;
ii. apply a first predictive model to the operational measurements to generate a predicted amine concentration of an amine component of the amine-based carbon capture solvent;
iii. apply a second predictive model to the operational measurements to generate a predicted degradation product concentration of a degradation product component of the amine-based carbon capture solvent, the second predictive model different from the first predictive model;
iv. generate a physical change detection event in response to determining that an amine concentration difference between the predicted amine concentration and a desired amine concentration is outside a predetermined amine difference threshold; and
v. generate a chemical degradation detection event in response to determining that a degradation product concentration difference between the predicted degradation product concentration and a desired degradation product concentration is outside a predetermined degradation product difference threshold.

13. The system of claim 12, wherein the first predictive model includes a machine learned model trained using property measurements of a training amine-based carbon capture solvent taken while the training amine-based carbon capture solvent is at a temperature of at least 35° C.

14. The system of claim 12, wherein the second predictive model includes a machine learned model trained using property measurements of a training amine-based carbon capture solvent taken while the training amine-based carbon capture solvent is at a temperature of at least 35° C.

15. The system of any one of claims 12 to 14, wherein the plurality of properties includes a refractive index, a density, a viscosity, and an ionic conductivity.

16. A method of detecting deterioration of an amine-based carbon capture solvent, comprising:
a. receiving operational measurements of a plurality of properties of the amine-based carbon capture solvent in a solvent circulation system of a carbon capture plant during operation of the carbon capture plant;
b. applying a predictive model to the operational measurements to generate a predicted concentration, the predicted concentration being a prediction of a concentration of a component of the amine-based carbon capture solvent;
c. determining a difference between the predicted concentration and a desired concentration;
d. determining that the difference is outside a predetermined threshold; and
e. generating a deterioration detection event in response to determining that the difference is outside the predetermined threshold.

17. The method of claim 16, further comprising determining a remediation action to adjust the predicted concentration towards the desired concentration.

18. The method of claim 16 or claim 17, further comprising capturing the operational measurements from the amine-based solvent while the amine-based carbon capture solvent is in a lean amine path from a desorber of the solvent circulation system.

19. The method of any one of claims 16 to 18, wherein the plurality of properties is selected from a group of properties including a refractive index, a density, a viscosity, an ionic conductivity, a thermal conductivity, a heat capacity, an electrical conductivity, a surface tension, an infrared (IR) radiation generated, or ultra violet (UV) radiation generated.

20. The method of any one of claims 16 to 18, wherein the plurality of properties includes a refractive index, a density, a viscosity, and an ionic conductivity.

21. A system for detecting deterioration of an amine-based carbon capture solvent, comprising:
a. at least one processor;
b. at least one data storage device communicatively coupled to the at least one processor, the at least one data storage device having stored thereon computer-executable instructions for operating the at least one processor to:
i. generate an interface for receiving operational measurements of a plurality of properties of the amine-based carbon capture solvent in a solvent circulation system of a carbon capture plant during operation of the carbon capture plant,
ii. apply a predictive model to the operational measurements to generate a predicted concentration, the predicted concentration being a prediction of a concentration of a component of the amine-based carbon capture solvent or of a degradation product,
iii. determine a difference between the predicted concentration and a desired concentration,
iv. determine that the difference is outside a predetermined threshold,
v. generate a deterioration detection event in response to determining that the difference is outside the predetermined threshold, and
vi. determine a remediation action to adjust the predicted concentration towards the desired concentration.

22. A method of detecting deterioration of an amine-based carbon capture solvent, comprising:
a. generating a user interface, the user interface prompting a user to provide operational measurements of a plurality of properties of the amine-based carbon capture solvent in a solvent circulation system of a carbon capture plant during operation of the carbon capture plant;
b. receiving, via the user interface, the operational measurements of the plurality of properties of the amine-based carbon capture solvent in the solvent circulation system of the carbon capture plant during operation of the carbon capture plant;
c. apply a predictive model to the operational measurements to generate a predicted concentration, the predicted concentration being a prediction of a concentration of a component of the amine-based carbon capture solvent or of a degradation product;
d. determine a difference between the predicted concentration and a desired concentration;
e. determine that the difference is outside a predetermined threshold;
f. generate a deterioration detection event in response to determining that the difference is outside the predetermined threshold; and
g. determine a remediation action to adjust the predicted concentration towards the desired concentration.
